(19) United States
(12) Patent Application Publication
(10) Pub. No.: US 2008/0281057 A1
(43) Pub. Date: Nov. 13, 2008

(54) Process For the Polymerisation of Vinyl-Containing Monomers

(75) Inventors: Marcus Pfaadt, Burgkirchen (DE); Heinz Klippert, Burgkirchen (DE)

Correspondence Address: EDWARDS ANGELL PALMER & DODGE LLP, P.O. BOX 55874, BOSTON, MA, 02205, US

(73) Assignee: VINNOLIT TECHNOLOGIE GMBH & CO. KG, BURGKIRCHEN (DE)

(21) Appl. No.: 11/795,088

(22) PCT Filed: Dec. 9, 2005
(86) PCT No.: PCT/EP2005/013252

§ 371 Date: Mar. 3, 2008

(30) Foreign Application Priority Data
Jan. 13, 2005 (DE) 10 2005 001 768.1

(51) Int. Cl. C08F 2/01; B01J 19/00

(52) U.S. Cl. 526/68; 422/138

(57) ABSTRACT

The invention relates to a process for the polymerisation of monomeric vinyl halides in a polymerisation reactor, especially using a flow-through cooler, and also to a polymerisation reactor for carrying out the process according to the invention. As a result, the space-time yield (STY) of an exothermal reaction can be substantially improved whilst the product quality remains almost the same.

The invention relates to a process for the polymerisation of vinyl-containing monomers such as monomeric vinyl halides in a polymerisation reactor using a flow-through cooler. The invention furthermore relates to a polymerisation reactor for carrying out the process according to the invention.

Polymerisation is an exothermal reaction in which usually large amounts of heat can be released (for example, 1550 kJ/kg in the case of the polymerisation of vinyl chloride). For reasons of economy, in the case of discontinuous polymerisation, large pressure vessels of up to 300 m³ are frequently used, so that substantial amounts of heat have to be removed. Therefore, for the discontinuous polymerisation of monomeric vinyl halides (for example, vinyl chloride) numerous processes and modifications of reaction vessels (reactors) have already been developed for improved removal of the heat of reaction.

In polymerisation technology it is known, for example from DE 197 23 977 and “Technical Progress für PVC”, Y. Saeki and T. Emura, Prog. Polym. Sci. 27 (2002) 2055-2131, to remove the resulting heat of reaction by way of walls of the reactor (jacket coolers), in which case removal of the heat of reaction is also referred to as cooling. However, in the case of cooling by way of the walls of the reactor it has to be borne in mind that with an increasing size of reactor, whilst the ratio of reactor height to diameter remains virtually the same, the ratio of cooling surface to volume decreases steadily.

In addition to a jacket cooler mounted on the outer reactor wall, a reactor having an internal cooler is also known; for example, see EP 0012410, U.S. Pat. No. 4,552,724 and Shinkai T., Shinko Pfaundler Tech Rep. 1988, 32(3) 21-6. In that instance, by reducing the thickness of the wall between the coolant and the internal space of the reactor, the heat transfer can be substantially improved. EP 0012410 describes, in particular, coolant-carrying half-coils mounted on the inner wall of the reactor, which bring about a significant increase in cooling performance.

The removal of heat by means of vapour cooling with the aid of a reflux condenser is also known; however, the cooling of polymerisation reactions using reflux condensers became technically feasible only at the end of the 1960s. A customary reflux condenser consists today of a vertical tube bundle, with a coolant, for example cooling water, flowing around the tubes. Condensation of gas flowing from the reactor chamber into the reflux condenser takes place inside the tubes. The condensate thereby formed then has to flow back into the reactor chamber in counterflow with respect to the gas flowing into the reflux condenser. It is disadvantageous therein that interactions between the gas and condensate streams meeting in the counterflow can be controlled only to a limited extent. For that reason the openings of, and connections between, the reactor and reflux condenser must be of such dimensions that the opposite flows do not, as far as possible, impede one another. However, in that case the technical limits set by pressure vessel safety are readily reached. A further problem of cooling using reflux condensers is that the returning condensate, on passing through the gas space of the reactor and arriving on the surface of the reaction mixture, has to be re-distributed in the reaction mixture, for example by stirring. For that purpose, generally, specific—usually onerous—stirring conditions have to be met in order for the arriving condensate to be stirred in homogeneously.

In general, heat is removed by means of evaporative heat transfer only in the upper region of the volume of the reaction mixture in the reactor, that is to say where gas bubbles are formed because of the hydrostatic pressure. In the lower region of the reactor, where no gas bubbles can form because of the higher hydrostatic pressure at the same temperature, cooling can take place only by circulating the reactor's contents. Circulation that is inadequate or stagnant can result in the reaction mixture becoming hotter in the lower region of the reactor than in the upper region before boiling of the reaction mixture starts. This results in a hotter liquid layer lying beneath a colder layer, which runs counter to the natural convection current in the reactor. Such a state is unstable; because of the rising current of hot liquid, liquid is moved upwards and spontaneously vaporises on reduction of the hydrostatic pressure. Such spontaneous vaporisation causes pronounced foaming of the reaction mixture and/or ejection of liquid from the reaction mixture, which is referred to as geysering. In order to avoid deposits in the reflux condenser, geysering can be suppressed, for example, by adding anti-foam agents, as described in JP 02180908. In addition, an inert gas introduced into the reactor, which gas can accumulate in the reflux condenser and has to be taken off in controlled manner, also has to be taken into account. Finally, the cooling performance of a reflux condenser also has to be matched to the removal of heat by the cooling jacket, which requires special control measures. Furthermore, the use of a reflux condenser for cooling a polymerisation reaction can result in the polymerisation products not being optimally balanced in terms of their characteristics, for example powder characteristics. In particular, the formation of so-called “fish eyes” is known to be a problem in the PVC-processing industry.

A further process for cooling is circulation of the reaction mixture through an external heat exchanger, which is described in EP 0526741. That process has two major problems. On the one hand, circulation of a dispersion readily results in deposition or even in clogging-up of the system and, on the other hand, a dispersion pump has a difficult to control influence on particle distribution. According to Saeki et al. in Prog. Polym. Sci. 27 (2002) 2055-2131, it cannot, to date, be stated with certainty whether this process is already in commercial use.

A problem of the present invention is to provide a process for the polymerisation of vinyl-containing monomers in a polymerisation reactor, which process is especially economical and can be operated with an improved space-time yield without deterioration of the characteristics of the product. In addition, it is a problem of the invention to provide an apparatus for carrying out the polymerisation process according to the invention.

The problem is solved by the subject-matter of the independent and dependent claims and of the description in conjunction with the Figures. The invention makes it possible to overcome the above-mentioned disadvantages of the prior art.

The invention accordingly relates to a polymerisation process in which vinyl-containing monomers—especially monomeric vinyl halides—are polymerised in a reactor, gaseous monomers from a gas space of the reactor are at least partially—preferably completely—condensed in a flow-through cooler, and the condensate is returned to the reactor. In accordance with the invention, the expression “polymerisation” includes both homopolymerisation of monomers and also copolymerisation of two or more different monomers. In addition, the invention relates to an apparatus enabling the process according to the invention to be carried out.

The polymerisation of vinyl-containing monomers, vinyl halides and, especially, vinyl chloride is known per se. However, it has now been found, surprisingly, that the process according to the invention allows openings between the reactor and flow-through cooler that are of substantially smaller dimensions than the reflux condensers used in the prior art. A flow-through cooler according to the present invention is especially a cooler wherein the vapour and condensate streams have the same direction of flow, that is to say the vapour stream flows into the cooler through one opening and, after condensation, the condensate stream flows out of the cooler through another opening, without the direction of flow changing or the two streams flowing in opposite directions. In accordance with the invention, a reactor can be a reaction vessel that is customary in the technical field and that can, for example, be hermetically sealed and is, if desired, provided with a stirrer etc.

It has furthermore been found that, with the process according to the invention, the space-time yield (STY) of polymerisation of monomeric vinyl halides in a polymerisation reactor is substantially improved whilst product quality remains almost the same. In particular it was found, surprisingly, that foaming of the reaction mixture and/or ejection of liquid from the reaction mixture is not observed in the case of the process according to the invention.

The reaction can, moreover, be better controlled by the present invention. As monomeric vinyl halide there is preferably used vinyl chloride, in which case the polymer produced can consist of, for example, from 50% to 100% vinyl chloride. Also preferably, identical or different monomer units can be polymerised in accordance with the invention to form a homo-, co- and/or ter-polymer. Advantageously, polymer products produced by the process according to the invention do not have fish eyes.

In accordance with the invention, the reaction can be carried out in solution or in dispersion, that is to say starting materials and/or products of the reaction can, independently of one another, be present in dissolved form in the solvent or be present as solids or liquids dispersed therein. In the process according to the invention, the polymerisation is preferably carried out in an aqueous dispersion, water being a preferred constituent. The vapour that is condensed in the flow-through cooler can include solvents, starting materials and/or products of the reaction and also mixtures thereof. In the case of the polymerisation of vinyl chloride, the vapour that is condensed in accordance with the process according to the invention includes gaseous monomeric vinyl chloride.

The condensate is preferably returned to the reactor in controlled manner, that is to say under automatic control and/or non-automatic control. The condensate can be returned, for example, with the aid of a pump, in which case the condensate is returned to the reactor preferably using an automatically controllable pump or metering pump.

Return of the condensate to the reaction vessel can, in principle, take place at any desired location in the reaction vessel. In one embodiment, the condensate is accordingly returned to a gas space of the reactor. In a further embodiment, the condensate is returned to a part of the reactor that contains liquid reaction mixture. As a result thereof, better mixing and improved cooling performance can be achieved. Special preference is given to returning the condensate to the lower region of the reactor, in order not to disrupt the convection current in the reactor. Furthermore, return into the reaction mixture, for example, in the vicinity of a stirrer, can ensure optimum mixing-in with the reaction mixture. As a result, circulation of the reaction mixture, dispersion or solution is assisted and not adversely affected. In accordance with a further embodiment, the condensate is returned to a plurality of regions of the reactor, for example to the vapour space of the reaction vessel and to the part that contains liquid reaction mixture. Return of the condensate to the reaction vessel can be carried out with or without automatic control. It is also possible in accordance with the invention for the polymerisation temperature to be automatically and/or non-automatically controlled by means of selection of the return flow location and/or the amount of return flow of condensate. Provision can also be made in accordance with the invention for the condensate to be fractionated, cleaned or the like before return to the reactor.

Preferably, the condensate is metered into the reaction mixture or dispersion, in which case special preference is given to the use of a pump for control of metering-in.

Preferably, the reaction mixture is stirred, as a result of which the heat exchange of the reaction mixture can be improved and/or accelerated. The process of the invention can be carried out under a pressure that is higher than normal pressure, preferably under a pressure of from 0.3 to 2 MPa. Preference is given to carrying out polymerisation discontinuously.

Preferably, the flow-through cooler used is a jacket cooler, in which a part of or all of the wall surface of the condenser is cooled. The flow-through cooler used can comprise, additionally or alternatively, one or more bundled tubes around which there flows a cooling medium, for example cooling water, condensation taking place in the interior of the tubes. In order that the condensate can better flow out of the cooler, the flow-through cooler can be arranged vertically or at an angle with a slope in the direction of flow of the condensate, the gas being introduced at the higher-arranged end of the flow-through cooler and the condensate being taken off at the lower-arranged end of the flow-through cooler. Special preference is given to arranging the flow-through cooler vertically, for example next to the reactor. Preferably, the flow-through cooler is automatically and/or non-automatically controlled by one or more valves and/or cocks between the reactor and cooler. The flow-through cooler can be switched in immediately the polymerisation temperature is reached, but is preferably switched in only after reaching a reaction of a few percent

In accordance with the invention, one or more further conventional coolers can also be used, in which case jacket coolers and/or internal coolers are preferred. In a preferred embodiment, reactor jacket cooling is additionally used in the process according to the invention, wherein a part of or all of the wall of the reaction vessel is cooled. Control of the reaction temperature can then take place, for example, by means of the reactor jacket and a valve between the flow-through cooler and the reactor.

The apparatus provided in order to carry out the process according to the invention is a reactor whose gas space is connected by way of a fluid connection, preferably a tubular connection, to a flow-through cooler, the condensate offtake line of the flow-through cooler being connected by way of at least one further fluid connection, preferably a tubular connection, to the reactor. Preferably, the flow-through cooler is arranged either vertically or at an angle with a slope in the direction of flow of the condensate. Special preference is given to an automatically controllable and/or non-automatically controllable pump for the condensate offtake line of the flow-through cooler, which is connected by way of at least one fluid connection, preferably a tubular connection, to the reactor. The reactor according to the invention preferably comprises at least one further cooler, special preference being given to at least one jacket cooler and/or internal cooler.

The present invention overcomes the disadvantages of the prior art, especially by substantially improving the space-time yield (STY) of polymerisation of monomeric vinyl halides whilst product quality remains almost the same and by suppressing foaming of the reaction mixture and/or ejection of liquid from the reaction mixture. Furthermore, it is possible to use openings between the reactor and flow-through cooler that are of substantially smaller dimensions than when employing a reflux condenser used in the prior art.

### DESCRIPTION OF THE FIGURES

The invention is explained hereinbelow with reference to Figures showing preferred embodiments of the apparatus according to the invention. Components having the same functions are referred to in the Figures by the same reference numerals.

FIG. 1 shows an embodiment of a polymerisation reactor according to the invention, which is used for carrying out the process according to the invention. The reactor 3, which is provided with a stirrer 1 and a jacket cooler 2, is connected by way of a fluid connection 4, preferably a tubular connection, which can contain an optionally non-automatically controllable and/or automatically controllable shut-off device X, preferably a valve or a cock, to a flow-through cooler 5 arranged at an angle. The condensate is returned by way of the further fluid connections 6 and 7, preferably tubular connections, by means of an automatically controllable and/or non-automatically controllable pump 8, to the lower region 9 of the reactor 3, which contains a reaction mixture 10.

FIG. 2 shows a further embodiment of a polymerisation reactor according to the invention, wherein the reactor 3, unlike in FIG. 1, is provided with an internal cooler 11 and a stirrer 1. The reactor 3 is connected by way of a fluid connection 4, preferably a tubular connection, which can contain an optionally non-automatically controllable and/or automatically controllable shut-off device X, preferably a valve or a cock, to a flow-through cooler 5 arranged at an angle, the condensate being returned directly by way of the further fluid connection 12, preferably a tubular connection, to a vapour space 13 of the reactor 3 containing a reaction mixture.

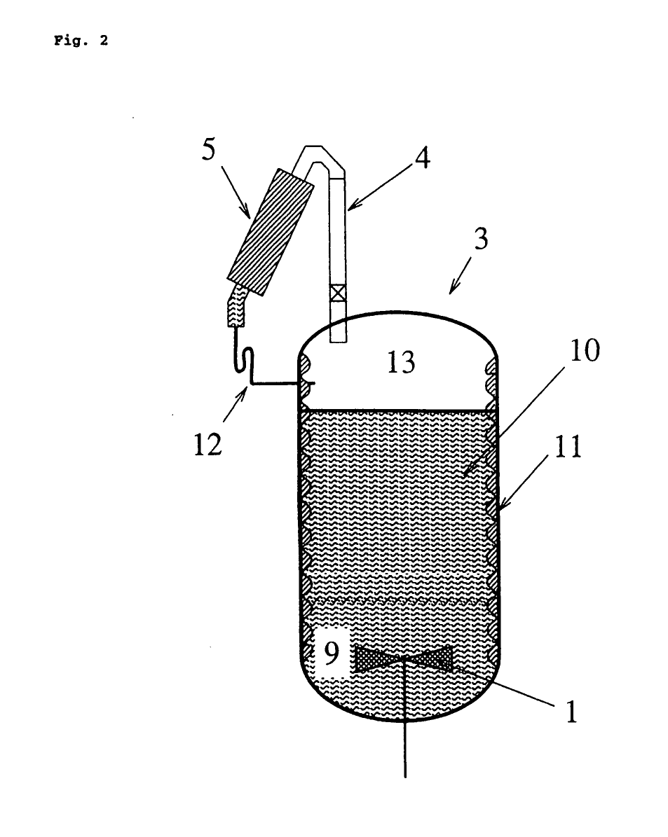

FIG. 3 shows a further embodiment of a polymerisation reactor according to the invention, wherein the reactor 3 is provided with an internal cooler 11 and a stirrer 1 and is connected by way of a fluid connection 4, preferably a tubular connection, which can contain an optionally non-automatically controllable and/or automatically controllable shut-off device X, preferably a valve or a cock, to a flow-through cooler 5 arranged at an angle. The condensate is returned by way of the further fluid connections 6 and 14, preferably tubular connections, by means of an automatically controllable and/or non-automatically controllable pump 8, in automatically controlled manner to a vapour space 13, to a middle region 15 and also to a lower region 9 of the reactor 3, which contains a reaction mixture 10.

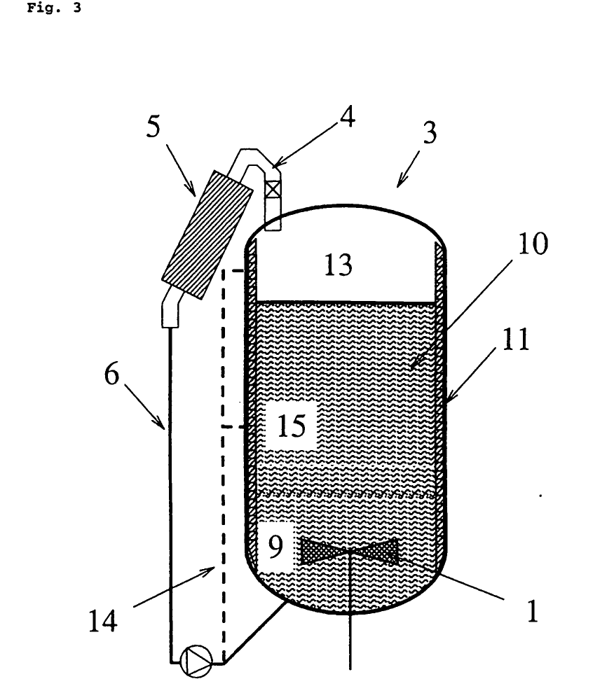

FIG. 4 shows a further embodiment of a polymerisation reactor according to the invention, wherein the reactor 3 is provided with an internal cooler 11 and a stirrer 1 and is connected by way of a fluid connection 4, preferably a tubular connection, which can contain an optionally non-automatically controllable or automatically controllable shut-off device X, preferably a valve or a cock, to a vertically arranged flow-through cooler 5. The condensate is returned by way of the further fluid connections 6 and 14 by means of an automatically controllable and/or non-automatically controllable pump 8, in automatically controlled manner to a vapour space 13, to a middle region 15 and also to a lower region 9 of the reactor 3, which contains a reaction mixture 10.

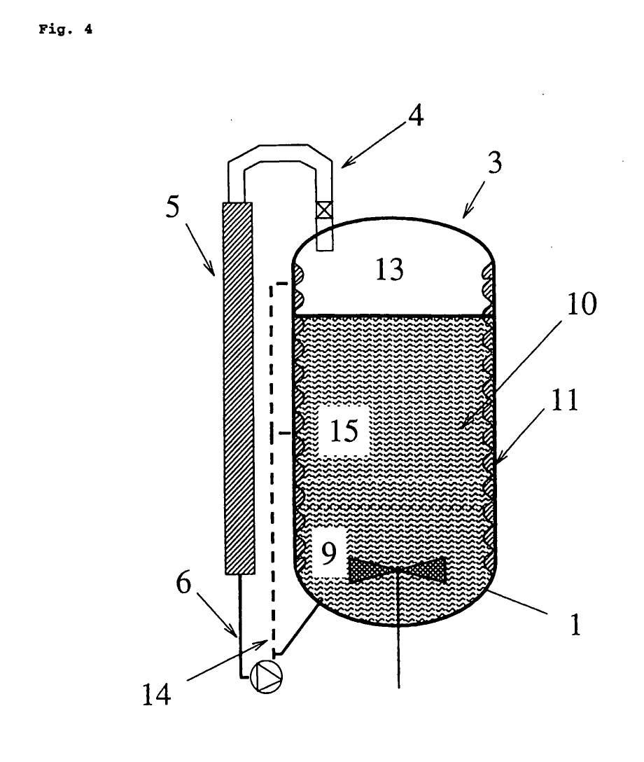

FIG. 5 shows a polymerisation reactor according to the prior art, wherein the reactor 3 containing a reaction mixture 10 is provided with an internal cooler 11 and a stirrer 1.

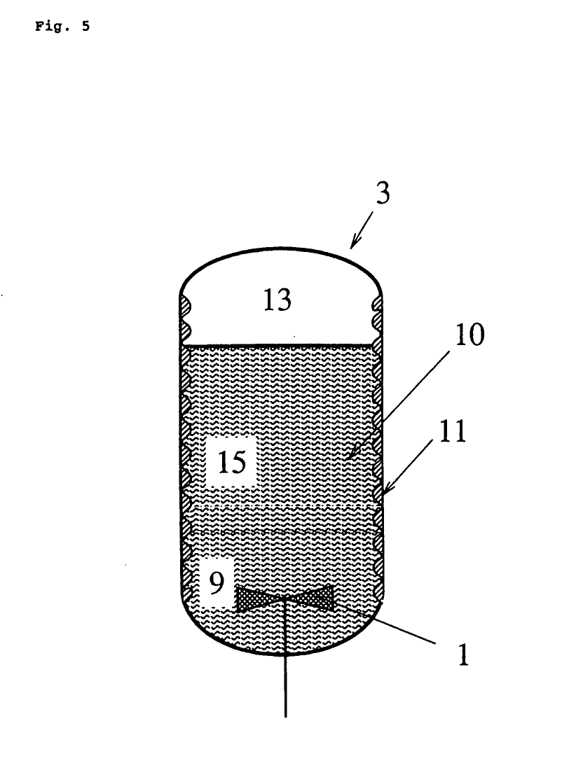

FIG. 6 shows another polymerisation reactor according to the prior art, wherein the reactor 3 containing a reaction mixture 10 is provided with a jacket cooler 2 and a stirrer 1 and is connected by way of a tubular connection 16 to a reflux condenser 17.

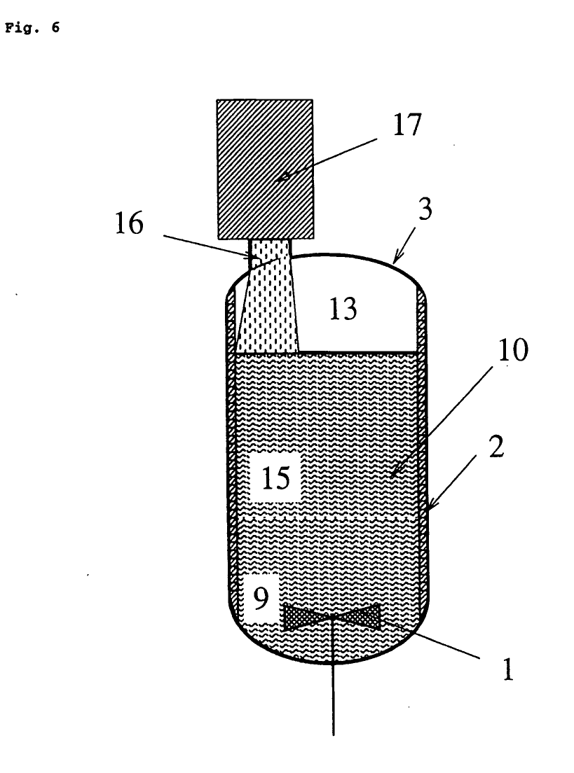

FIG. 7 shows a further polymerisation reactor according to the prior art, wherein the reactor 3 containing a reaction mixture 10 is provided with a jacket cooler 2 and a stirrer 1 and is connected by way of a tubular connection 16 to a reflux condenser 17. The reactor 3 is furthermore connected, for circulation cooling of the dispersion, to an external heat exchanger 18 by way of the further tubular connections 19 and 20.

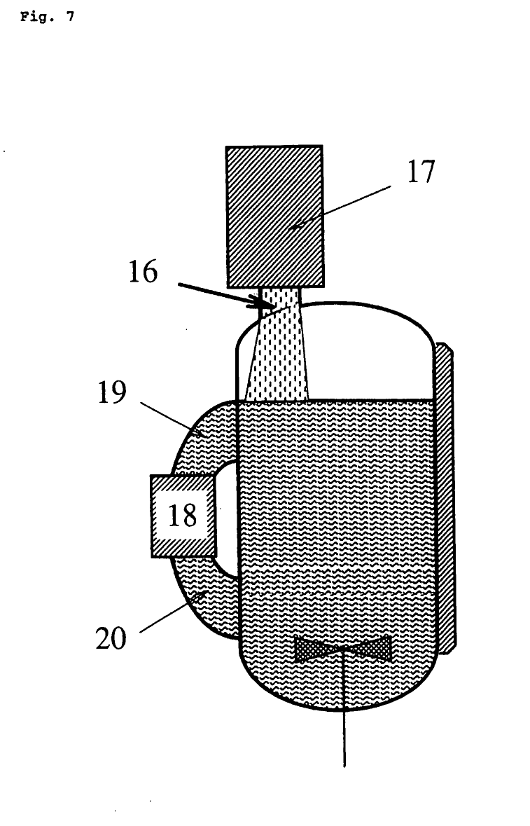

FIG. 8 shows the course of the cooling water temperature observed in Example 1.

FIG. 9 shows the course of the cooling water temperature observed in Example 2.

### EXAMPLES

### Example 1

### S-PVC, K-Value 68

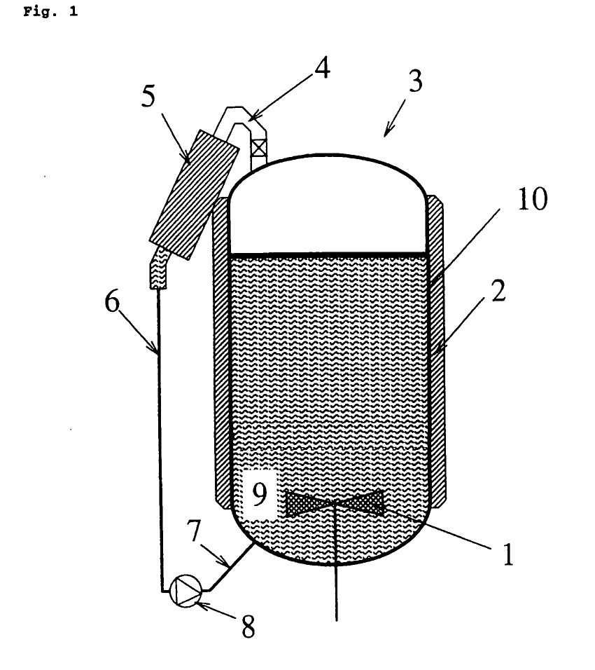

Polymerisation of vinyl chloride was carried out at a temperature of 57° C. in a 1 m³ test reactor having a jacket cooling surface of about 4.8 m². Commercially available suspension agents and, as initiator, a peroxydicarbonate were used. The temporal sequence of addition of the individual substances does not in this case have any effect on the process. The external flow-through cooler had a surface area of 5 m² and was installed at an angle in the direction of flow (see FIG. 1) but it can also be oriented parallel to the reactor. Vinyl chloride vaporised during the reaction was condensed in the flow-through cooler and returned by means of a pump having a pumping capacity of 240 l/h to a lower region of the reaction vessel. No increased foam formation was observed and no geysering occurred.

For producing a comparison, the same reactor was used with the same settings and under the same conditions, but without an external flow-through cooler.

Under the assumption that the heat of evaporation of vinyl chloride is about 20 kJ/mol and the heat of polymerisation is 71.2 kJ/mol, the resulting efficiency for the flow-through cooler component is about 79%. The powder characteristics of the product produced in accordance with the process of the invention are shown in Table 1 together with those of the product produced in accordance with the comparison process.

It was found that the powder characteristics of the products of the two processes showed no significant differences.

TABLE 1
Powder characteristics of S-PVC, K-value 68

| | | Comparison, | Invention, |
|---|---|---|---|
| | | without | with |
| | | flow-through | flow-through |
| S-PVC, K-value 68 | Unit | cooler | cooler |
| K-value | [-] | 66.1 | 66.7 |
| Bulk density | [g/l] | 552 | 548 |
| Porosity | [%] | 21.6 | 21.3 |
| Average particle diameter | [μm] | 179.8 | 179.6 |
| Sieve residue >63 | [%] | 100 | 100 |
| Sieve residue >250 | [%] | 13.5 | 17.3 |
| Sieve residue >355 | [%] | 0.5 | 0.2 |
| Measure of breadth of | [-] | 2.22 | 2.26 |
| particle distribution | | | |

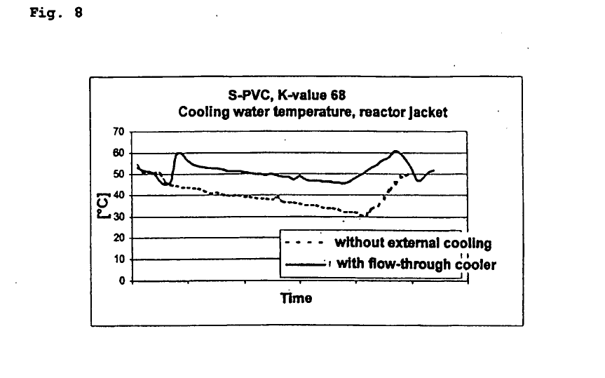

The course of the cooling water temperature as a function of time, observed in Example 1, is shown in FIG. 8. The cooling water requirement is considerably lower when the flow-through cooler is used. The flow-through cooler was brought into operation only after reaching a reaction of a few percent, which can be clearly seen from the rapid temperature increase in the starting phase.

### Example 2

### S-PVC, K-Value 70

Polymerisation of vinyl chloride was carried out at a temperature of 53° C. using the reactor, the conditions and the procedure as described in Example 1. Additions of suspension aids and concentrations of initiators were modified in line with requirements of the test.

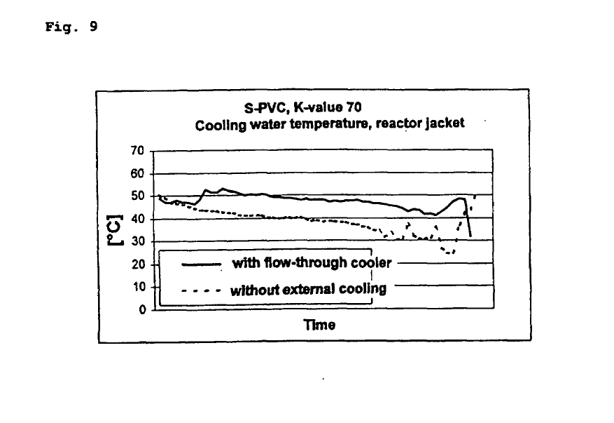

The particular cooling water temperatures as a function of time are shown in FIG. 9. The cooling water requirement is considerably lower when the flow-through cooler is used. The flow-through cooler was brought into operation only after reaching a reaction of a few percent, which can be clearly seen from the rapid temperature increase in the starting phase. It can clearly be seen that, when the flow-through cooler is not used, the cooling water temperature follows a very unsteady course, the reason being a heterogeneous temperature distribution in the reactor. A clear steadying of the course of the curve can be seen, when the flow-through cooler is used, because circulation of the dispersion is assisted by metering-in of the condensate in the reactor. It was found that the powder characteristics were not subject to any significant change (Tab. 2).

TABLE 2
Powder characteristics of S-PVC, K-value 70

| | | Comparison, | Invention, |
|---|---|---|---|
| | | without | with |
| | | flow-through | flow-through |
| S-PVC, K-value 70 | Unit | cooler | cooler |
| K-value | [-] | 69.9 | 69.4 |
| Bulk density | [g/l] | 472 | 480 |
| Porosity | [%] | 30.6 | 31.1 |
| Average particle diameter | [μm] | 127 | 127.2 |
| Sieve residue >63 | [%] | 99.7 | 99.7 |
| Sieve residue >125 | [%] | 65.9 | 66.2 |
| Sieve residue >250 | [%] | 0.4 | 0.3 |
| Measure of the breadth of | [-] | 2.33 | 2.3 |
| particle distribution | | | |

### Example 3

### Random Copolymer of Vinyl Chloride and Vinyl Acetate, K-Value 57

The polymerisation temperature was 60.5° C. The other test conditions were analogous to Example 1.

TABLE 3
Powder characteristics of VC/VA copolymer, K-value 57

| | | Comparison, | Invention, |
|---|---|---|---|
| | | without | with |
| | | flow-through | flow-through |
| VC/VAC copolymer | Unit | cooler | cooler |
| K-value | [-] | 58 | 57 |
| Bulk density | [g/l] | 606 | 606 |
| Porosity | [%] | 4.8 | 4.9 |
| Average particle diameter | [μm] | 225 | 169 |
| Sieve residue >63 | [%] | 100 | 100 |
| Sieve residue >125 | [%] | 98 | 95 |
| Measure of the breadth of | [-] | 1.93 | 2.26 |
| particle distribution | | | |

### Example 4

### Production of an Extender Resin, K-Value 66

The polymerisation temperature was 59° C. The other test conditions were analogous to Example 1.

TABLE 4
Powder characteristics of extender resin, K-value 66

| | | Comparison, | Invention, |
|---|---|---|---|
| | | without | with |
| | | flow-through | flow-through |
| Extender resin | Unit | cooler | cooler |
| K-value | [-] | 64 | 64 |
| Bulk density | [g/l] | 551 | 585 |
| Porosity | [%] | 7.6 | 7.3 |
| Average particle diameter | [μm] | 30 | 34 |
| Sieve residue >33 | [%] | 53 | 67 |
| Sieve residue >90 | [%] | 0.7 | 3.6 |

### Example 5

Production of a Graft Copolymer of Vinyl Chloride and Polybutyl Acrylate

The polymerisation temperature was 59° C. The other test conditions were analogous to Example 1.

TABLE 5
Powder characteristics of VC/ACR graft copolymer

| | | Comparison, | Invention, |
|---|---|---|---|
| | | without | with |
| | | flow-through | flow-through |
| VC/ACR graft copolymer | Unit | cooler | cooler |
| K-value | [-] | 64.5 | 63 |
| Bulk density | [g/l] | 621 | 601 |
| Porosity | [%] | 12.3 | 12.7 |
| Average particle diameter | [μm] | 185 | 192 |
| Sieve residue >63 | [%] | 97 | 100 |
| Sieve residue >250 | [%] | 25 | 26 |
| Measure of the breadth of | [-] | 3.11 | 2.34 |
| particle distribution | | | |

1-24. (canceled)

25. A polymerisation process comprising charging a reactor with vinyl-containing monomers, gaseous monomer from a gas space of the reactor is condensed in a flow-through cooler and the condensate is returned to the reactor.

26. A process of claim 25 wherein the vinyl-containing monomers comprise a monomeric vinyl halide.

27. A process of claim 25 wherein the vinyl-containing monomers comprise a vinyl chloride.

28. A process of claim 25 wherein the polymerisation is carried out in a dispersion or a solvent.

29. A process of claim 28 wherein the polymerisation is carried out in aqueous suspension.

30. A process of claim 25 wherein the condensate is returned to the reactor under automatic and/or non-automatic control.

31. A process of claim 25 wherein the condensate is returned to the reactor using a pump capable of being automatically controlled and/or of being metered.

32. A process of claim 25 wherein the condensate is returned to the gas space of the reactor.

33. A process of claim 25 wherein the condensate is returned to that part of the reactor which contains the liquid reaction mixture.

34. A process of claim 25 wherein the condensate is returned to a plurality of regions of the reactor.

35. A process of claim 25 wherein the polymerisation temperature is automatically and/or non-automatically controlled by means of selection of the return flow location of the condensate.

36. A process of claim 25 wherein the polymerisation temperature is automatically and/or non-automatically controlled by means of selection of the amount of return flow of the condensate.

37. A process of claim 25 wherein the polymerisation is carried out at a pressure of from 0.3 to 2 MPa.

38. A process of claim 25 wherein the polymerisation is carried out discontinuously.

39. A process of claim 25 wherein the flow-through cooler is a jacket cooler.

40. A process of claim 25 wherein the flow-through cooler comprises one or more bundled tubes.

41. A process of claim 25 wherein heat of reaction is removed, in addition, by way of at least one further cooler.

42. A process of claim 41 wherein the at least one further cooler comprises a jacket cooler.

43. A process of claim 41 wherein the at least one further cooler comprises an internal cooler.

44. An apparatus for carrying out the process according of claim 25 wherein the gas space of the reactor is connected by way of a fluid connection to a flow-through cooler and the offtake line of the flow-through cooler is connected by way of at least one further fluid connection to the reactor.

45. An apparatus of claim 44 wherein the flow-through cooler is arranged vertically.

46. An apparatus of claim 44 wherein the longitudinal axis of the flow-through cooler is arranged at an angle of less than 90° to the vertical.

47. An apparatus of claim 44 wherein an automatically and/or non-automatically controllable pump is connected to the offtake line of the flow-through cooler and the at least one fluid connection to the reactor.

48. An apparatus of claim 44 wherein the apparatus comprises at least one further cooler.
